(19) United States
(12) Patent Application Publication
(10) Pub. No.: US 2006/0038530 A1
(43) Pub. Date: Feb. 23, 2006

(54) System and method for optimizing motor performance by varying flux

(75) Inventor: George Holling, Riverton, UT (US)

Correspondence Address: JONES DAY, 2882 SAND HILL ROAD, SUITE 240, MENLO PARK, CA, 94025, US

(73) Assignee: RT Patent Company, Inc., Wilmington, DE (US)

(21) Appl. No.: 11/089,873

(22) Filed: Mar. 25, 2005

Related U.S. Application Data
(63) Continuation-in-part of application No. 10/885,103, filed on Jul. 7, 2004.

(51) Int. Cl. H02P 7/42

(52) U.S. Cl. 318/807

(57) ABSTRACT

A system for operating an electric motor is described. The system has a torque estimator to determine a load on the motor and a controller configured to generate a motor control signal. The controller continuously adjusts the motor control signal in response to the load on the motor. The motor control signal optimizes the motor's performance by controlling the rotor flux of the motor. The motor control signal can control the voltage or current and frequency applied to the motor.

### RELATED APPLICATION

This application is a continuation-in-part of U.S. patent application Ser. No. 10/885,103 filed Jul. 7, 2004, the contents of which are incorporated by reference herein.

### FIELD OF THE INVENTION

The present invention generally relates to controllers for electric motors and more specifically to a controller which can vary the voltage and frequency of the power applied to the motor in order to obtain maximum efficiency at any load.

### BACKGROUND OF THE INVENTION

Controllers for electric motors provide electrical energy to the motor for proper operation. Typically, the controller applies a voltage or current to the motor at a prescribed frequency. The voltage and frequency are chosen to optimize the speed and torque output of the motor.

It has been shown that with an AC induction motor, the torque output of the motor can be improved if an over-voltage condition is applied. During this condition, the motor is operated in a partial saturation condition due to the magnetization current at low loads. However, the efficiency of the motor is decreased at lower speeds when operated in the over-voltage condition.

Currently, motor controllers can use vector control algorithms for operating the motor at maximum efficiency. Vector control algorithms are complex mathematical formulas which model the operation of the motor and use real-time monitoring of the motor. Specifically, the vector control algorithms are a closed-loop feedback system that control the phase relationships between the input voltages. In order for the vector control algorithm to be effective, very sensitive measurements of the operating parameters of the motor are needed. In this respect, vector control algorithms require very sensitive and expensive sensors to measure the operation of the motor. In addition, vector control algorithms seek to maintain a constant peak rotor flux to yield maximum dynamic bandwidth.

Accordingly, there is a need for a motor controller to operate an electric motor in an efficient manner at different load conditions without the use of sensitive or complex control techniques.

### SUMMARY OF THE INVENTION

A controller is disclosed for operating an electric motor having a rotational speed and using electrical current. The controller has a voltage or current controller for generating a voltage control signal in response to the speed and current usage of the motor wherein the voltage control signal represents an efficient operating mode of the motor. Furthermore, the controller has a frequency controller for generating a frequency control signal in response to the speed and current usage of the motor wherein the frequency control signal represents an efficient operating mode of the motor. The controller further includes a multiplier for combining the frequency control signal and the voltage control signal. The combined signal from the multiplier is applied to the voltage operating the motor such that the motor operates in an efficient manner for the given load.

A method for controlling an electric motor includes generating a voltage or current control signal in response to the speed (rotational frequency) of the electric motor and the current usage of the motor wherein the voltage control signal represents an efficient operating mode of the motor. Furthermore, a frequency control signal is generated in response to the speed of the motor and the current usage of the motor wherein the frequency control signal represents an efficient operating mode of the motor. The frequency and voltage control signals are combined and applied to the voltage operating the motor so that the motor operates efficiently for a given load.

A system for controlling an electric motor includes a speed sensor for measuring the rotational speed (rotational frequency) of the electric motor and generating a speed sensing signal in response thereto. The system further includes a current sensor for generating a current sensing signal in response to the current usage of the motor. A voltage controller of the system generates a voltage control signal in response to the speed sensing signal and the current sensing signal. The voltage or current control signal represents an efficient operating mode of the motor. Similarly, a frequency controller of the system generates a frequency control signal in response to the speed sensing signal and the current sensing signal. The frequency control signal also represents an efficient operating mode of the motor. The system further includes a multiplier for combining the frequency control signal and the voltage or current control signal. The combined signal is then applied to the voltage or current operating the motor.

A method for controlling an electric motor comprises determining an operating load of the electric motor. The voltage or current to be applied to the electric motor is then calculated in response to the load. The calculated voltage operates the motor in an efficient mode. Similarly, the frequency of the voltage or current that operates the electric motor is calculated in response to the operating load of the electric motor. The frequency and voltage is calculated such that the motor operates in an efficient mode. The calculated voltage or current is applied to the motor at the calculated frequency in order to operate the motor in an efficient manner.

Furthermore, a system for operating an electric motor is described. The system has a torque estimator to determine the load on the motor and a controller in communication with the torque estimator and the motor. The controller is configured to generate a motor control signal to the motor that continuously optimizes the motor's performance in response to the load of the motor.

A conventional AC motor controller (V/F or Flux Vector Control) attempts to maintain a fixed maximum value of rotor flux in the machine, whereas in the present invention, the value and phase angle of rotor flux for each load and speed are optimized in order to achieve optimal motor performance.

The optimization can be calculated using models or a lookup table to generate the motor control signal. The lookup table contains values of motor voltage or current and its respective frequency that optimizes motor performance for a given load. The values of the lookup table can be either found from experimentation or computer modeling of the motor's characteristics.

A method for controlling an electric motor is also described. The method comprises estimating a load on the motor and generating a continuously variable motor control signal in response to the load. The motor control signal typically controls the flux of the rotor and can be adjusted by controlling the voltage and frequency applied to the motor or the current and frequency applied to the motor.

### BRIEF DESCRIPTION OF THE DRAWINGS

These, as well as other features of the present invention, will become apparent upon reference to the drawings wherein:

FIG. 1 is a block level diagram of a motor controller;

FIG. 2 is a flowchart illustrating the method of controlling an electric motor with the motor controller illustrated in FIG. 2; and

FIG. 3 is a block level diagram of a motor controller constructed according to a second embodiment of the present invention.

### DETAILED DESCRIPTION

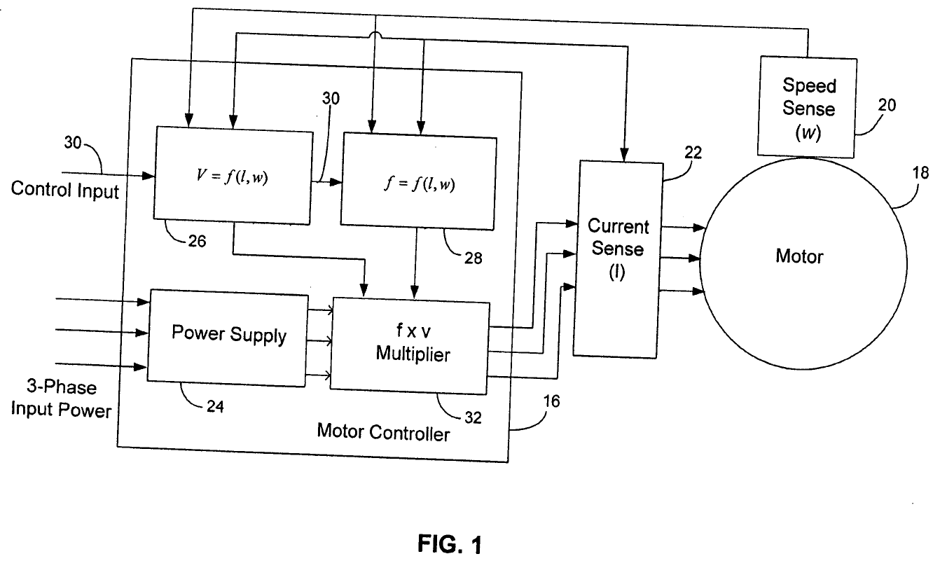

Referring now to the drawings wherein the showings are for purposes of illustrating preferred embodiments, and not for purposes of limiting the same, FIG. 1 is a block level diagram of a motor controller 16 used to control the operation of a 3-phase AC induction motor 18. The motor 18 may be a conventional AC induction type motor, or a motor operative with an increased stator/rotor air gap as described by Assignees co-pending patent applications Ser. No. 10/821,797, (Attorney Docket No. 146962-900002) and Ser. No. 10/894,688, (Attorney Docket No. 146962-999006), the contents of which are incorporated herein by reference.

The load of the motor is determined with a speed sense 20 and a current sense 22. Specifically, the speed sense 20 measures the rotational speed (w) of the motor 18 through either a sensor or sensor-less detection mechanism, as is commonly known and described in U.S. Pat. No. 5,600,218 entitled SENSORLESS COMMUTATION POSITION DETECTION FOR BRUSHLESS MOTORS, the contents of which are incorporated herein by reference. The speed sense 20 generates a speed sensing signal that is related to the rotational speed (ω). Similarly, the current sense 22 measures the electrical current (I) that the motor 18 is using. For a three phase motor, the current sense 22 measures the RMS phase currents for each phase of the motor 18. The current sense 22 generates a current sensing signal that represents the total current (I) that the motor is using. In this regard, the current (I) and rotational speed (ω) indicate the load being placed on the motor 18.

The controller 16 uses the current (I) and the speed (ω) to determine the frequency and the amount of the voltage or current to be applied to the motor 18 such that the motor 18 operates in an efficient manner. The controller 1 6 has a power supply 24 to generate a regulated voltage or current that is applied to the motor 18. For the example shown in FIG. 1, the AC induction motor 18 is a three-phase motor. Accordingly, the power supply 24 regulates 3-phase input power that is applied to the motor 18. It is also possible to control the current applied to the motor during operation. In this respect, it is possible to use a current controller in place of the voltage controller to provide more accurate control. Accordingly, throughout this application a current controller can replace the voltage controller.

The controller 16 has a voltage or current controller 26 that produces a voltage or current control signal in response to the speed (ω) and current (I) of the motor. Specifically, the speed sensing signal from the speed sense 20 and the current sensing signal from the current sense 22 are inputs into the voltage controller 26. As previously discussed, the load on the motor 18 can be determined from the current usage and speed of the motor 18. The voltage controller 26 determines the amount of voltage that should be applied to the motor 18 based on the current sensing signal and the speed sensing signal to achieve the maximum efficiency of the motor 18.

Similarly, the controller 16 has a frequency controller 28 for regulating the frequency of the applied voltage or current. The speed sensing signal from the speed sense 20 and the current sensing signal from the current sense 22 are input into the frequency controller 26. The frequency controller 28 determines the frequency of the voltage or current to be applied to the motor 18 based on the current sensing signal and the speed sensing signal to achieve the optimized rotor flux of the motor 18.

The frequency controller 28 and the voltage controller 26 determined the frequency and amount of voltage to be applied to achieve the optimal motor performance based upon the load and efficiency of the motor 18. Specifically, each of the controllers 26, 28 has a voltage/frequency curve for each operating speed of the motor 18. The voltage/frequency curve may be expressed as a mathematical formula or as a table containing values. The voltage/frequency curve is determined through either experimental testing of the motor 18 to determine the amount of voltage or current and frequency to be applied to obtain the maximum efficiency, or by simulating the motor 18 with a computer to obtain the curves [for a given rpm].

The voltage/frequency (e.g., voltage as a function of rotational speed) or current/frequency curves (e.g., current as a function of rotational speed) maximize the efficiency of the motor by over exciting the motor at higher loads. In this respect, the maximum efficiency of the motor is obtained at any load and the motor operates at maximum efficiency over its full range of torque at any speed. The frequency of the voltage or current applied to the motor is controlled to allow the motor to operate at a speed that limits internal saturation of the motor's steel and thus maximizes the motor's operating frequency. Also, the motor's efficiency is improved by reducing the operating voltage or current of the motor when it is operated at a constant speed below the motor's rated torque. The voltage/frequency or current/frequency curves take into account the motor's operating characteristics in order to determine the amount of voltage or current and the frequency that should be applied in order to operate the motor 18 efficiently. A control input 30 allows an operator to vary the curves and operate the motor a desired setting.

The voltage control or current control signal from the voltage controller 26 and the frequency control signal from the frequency controller 28 are inputted into a signal multiplier 32 which combines the signals together. The multiplier 32 applies the control signals to the motor 18 from the power supply 24 in order to control the frequency and voltage of the power supplied to the motor 18. Specifically, the multiplier 32 regulates the power from the power supply 24 in response to the voltage control signal and the frequency control signal. In this regard, the power applied to the electric motor 18 operates the motor efficiently for the given load.

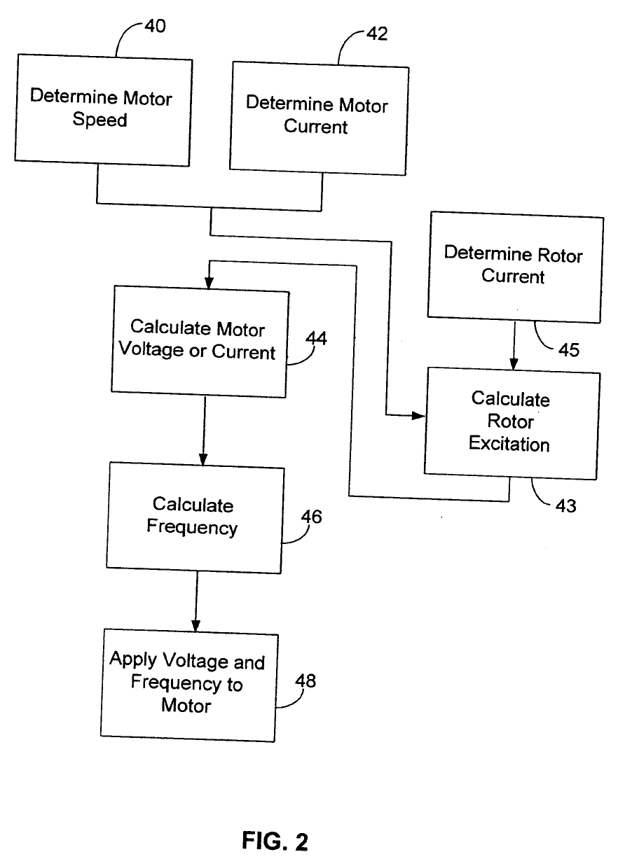

Referring to FIG. 2, a flowchart showing the operation of the controller 16 is shown. In steps 40 and 42, the load on the motor 18 is determined. Specifically, in step 40, the speed of the motor 18 is determined, while in step 42, the current that the motor 18 is using is determined. Next, in step 43, the rotor excitation is calculated in response to the rotor current determined in step 45. In step 44, the voltage or current that should be applied to the motor is calculated by the voltage controller 26. In step 46, the frequency of the voltage that is applied to the motor 18 is calculated by the frequency controller 28. The calculated voltage or current and frequency are applied to the motor 18 in step 48.

It will be recognized by those of ordinary skill in the art that the controller 16 can be embodied as either discrete electronic components or as instructions performed on a multi-purpose computer. In this regard, it is possible that the method as illustrated in FIG. 2 can be embodied as programming instructions stored on a computer-readable medium (i.e., disk drive, memory, etc . . . ) that are implemented on a processor or processor containing system. Similarly, the voltage controller 26, frequency controller 28 and the multiplier 32 may be implemented as instructions or programming modules of a computer program.

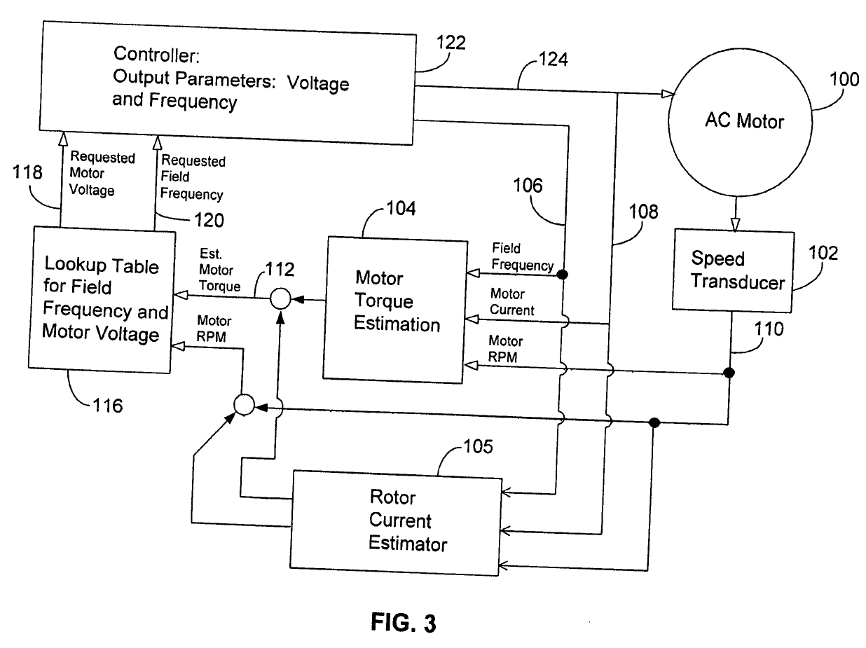

Referring to FIG. 3, a second embodiment of the present invention is shown whereby the torque of the motor is estimated and a lookup table is used to determine the motor voltage or current and frequency. In FIG. 3, the speed of an AC motor 100 is detected by a speed transducer 102 that generates a motor RPM signal 110. The speed of the motor is the rotational speed of the motor shaft and can detect of the slip of the rotor in relation to the stator. A motor torque estimation module 104 determines the estimated torque experienced by the motor 100 from motor RPM signal 110, motor current signal 108 and field frequency 106. The motor RPM signal 110 is from the speed transducer 102, while the motor current signal 108 is the measured current that the motor 100 is using. The field frequency signal 106 is the frequency of the voltage applied to the motor 100. The motor torque estimation module 104 determines the torque on the motor in order to generate an estimated motor torque signal 112 that indicates the load on the motor 100. A rotor current estimator 105 also generates an estimated motor torque signal 112 and motor RPM signal 110. The field frequency signal 106, motor current signal 108 and motor RPM signal 110 are inputted in to the rotor current estimator 105.

The estimated motor torque, as well as the motor speed are used by a lookup table 116 to determine the amount of voltage or current and frequency of the voltage to be applied to the motor 100. Specifically, the estimated motor torque signal 112 and the motor RPM signal 110 are inputted into the lookup table 116. The lookup table 116 contains values of the applied motor voltage and the frequency as a function of speed and load to maximize rotor flux and give optimal motor performance. These values avoid saturation of the rotor and stator at a level whereby temperature effects are not of a concern. In this respect, the values contained in the lookup table 116 maximize power output and efficiency of the motor by optimally increasing the motor's excitation at an acceptable maximum level without saturating the motor's steel. The lookup table 116 can be implemented as a two-dimensional matrix whereby motor torque (i.e., load) and motor RPM (i.e., rotational frequency) are used to find the optimal motor voltage or current and field frequency. In this regard, the lookup table 116 outputs a requested motor voltage signal 118 and a requested field frequency signal 120 to a controller 122. The lookup table 116 can interpolate between points in order to determine the best values for the signals. Alternatively, interpolation does not need to be used if suitable key operating points are chosen.

The values in the lookup table 116 are determined by finding the optimal performance characteristics of the motor 100 for the given load. These values can be found by testing the motor, or by computer modeling the motor. In this respect, the requested motor voltage or current control signal 118 and the requested field frequency signal 120 provide input to the controller 122 in order to adjust the rotor flux of the motor to an optimal value of rotor magnetization current for the given load of the motor 100. The optimal magnetization current can be controlled by adjusting the frequency and voltage or current applied to the motor 100. It is also possible to control both the magnetization current of the rotor as well as the torque producing stator current independently to operate the motor 100 at optimal performance. Furthermore it is also possible to vary the flux of the motor, i.e., using vector control methods, in order to achieve optimal performance. To maintain superior dynamic performance, the preferred implementation is using current control, rather than voltage control, although voltage control can be implemented using a feed forward control to achieve the desired transient dynamic response.

The method of the controlling the motor 100 provides dynamic transient compensation by being capable of briefly applying a high voltage. This overcomes the drawback of a reduced dynamic response that a common vector control algorithm would experience. The dynamic transient compensation briefly applies a high voltage which results in a high rate of change in the rotor current or alternatively a high current of the appropriate frequency is injected briefly in to the stator to rapidly change the rotor field. The result is a virtually instantaneous change in the motor's excitation and a resulting high bandwidth dynamic response. The rapid change in rotor current is implemented using the above described method of the invention such that a sufficiently high current is injected into the stator thereby controlling both the excitation and frequency. A quasi stable operating condition is maintained once the desired excitation has been achieved.

The controller 122 generates a motor control voltage or current signal 124 that is applied to the motor 100. Specifically, the controller 122 provides an excitation to the motor 100 at a determined frequency for optimal performance given the load on the motor 100. Also, the controller 122 generates the field frequency signal 106 to the motor torque estimation module 104 that is used to determine the load on the motor 100. The voltage or current and frequency applied to the motor 100 are in response to the requested motor voltage signal 118 and the requested field frequency signal 120. The controller 122 determines the proper voltage and frequency of the power to be applied to the motor 100 based upon the signals from the lookup table 116. The controller may include an input for a user to modify the power applied to the motor 100 as desired such as to vary the speed of the motor if necessary.

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalents thereof are intended to be embraced.

What is claimed is:

1. A system for operating an electric motor, the system comprising:
a torque estimator to determine a load on the motor; and
a controller in communication with the torque estimator and the motor, the controller configured to generate a motor control signal to the motor that continuously optimizes the motor performance by continuously varying motor flux in response to the load of the motor.

2. The system of claim 1 wherein the motor has a rotor and the controller continuously varies rotor flux to achieve optimal performance.

3. The system of claim 1 wherein the load on the motor is determined from the speed and torque of the motor.

4. The system of claim 3 wherein the motor speed is the rotational speed of the motor.

5. The system of claim 4 wherein the rotational speed of the motor is determined by a speed transducer.

6. The system of claim 1 further comprising a lookup table in communication with the controller and the torque estimator, the lookup table containing values of motor voltage and voltage frequency that are used by the controller to generate the motor control signal.

7. The system of claim 6 wherein the lookup table generates the motor voltage and the voltage frequency in response to the load on the motor and the motor speed.

8. The system of claim 1 further comprising an optimization algorithm configured to generate the motor control signal in response to the load on the motor.

9. A method of controlling an electric motor, the method comprising the steps of:
estimating a load on the motor; and
generating a motor control signal to the motor that continuously optimizes motor performance by varying flux in the motor in response to the load on the motor.

10. The method of claim 9 wherein the step of generating the motor control signal comprises continuously varying rotor flux of the motor in order to optimize motor performance.

11. The method of claim 10 wherein the rotor flux is varied by controlling magnetization current.

12. The method of claim 10 wherein the rotor flux is varied by controlling the voltage applied to the motor.

13. The method of claim 10 wherein the rotor flux is varied by controlling the current applied to the motor.

14. The method of claim 9 wherein the step of estimating the load on the motor comprises estimating the torque on the motor.

15. The method of claim 14 wherein the step of estimating the load on the motor further comprises estimating the speed of the motor.

16. The method of claim 14 wherein the step of estimating the torque on the motor comprises calculating the torque of the motor in response to motor current, motor speed and voltage frequency applied to the motor.

17. The method of claim 9 wherein the step of generating the motor control signal comprises determining values of the motor control signal from a lookup table in response to the load on the motor.

18. The method of claim 9 wherein the step of generating the motor control signal comprises determining value of the motor control signal with an optimization algorithm in response to the load on the motor.

19. A method of controlling an electric motor comprising the step of briefly applying a high voltage to the motor thereby inducing a high rate of change in a rotor current to instantaneously change the motor's excitation for improved dynamic response.

20. A method of controlling an electric motor comprising the step of injecting a high current into a stator of the motor to induce a rapid change in a magnetic field of the rotor for improved dynamic response.
